(19) United States
(12) Patent Application Publication
(10) Pub. No.: US 2020/0255596 A1
(43) Pub. Date: Aug. 13, 2020

(54) POLYIMIDE RESIN AND PRODUCTION METHOD THEREFOR, POLYIMIDE SOLUTION, AND POLYIMIDE FILM AND PRODUCTION METHOD THEREFOR

(71) Applicant: KANEKA CORPORATION, Osaka-shi (JP)

(72) Inventors: Yasutaka KONDO, Otsu-shi (JP); Hiroyuki USHIRO, Settsu-shi (JP); Shoto BANYA, Otsu-shi (JP); Masahiro MIYAMOTO, Settsu-shi (JP)

(73) Assignee: KANEKA CORPORATION, Osaka-shi (JP)

(21) Appl. No.: 16/755,216

(22) PCT Filed: Jun. 1, 2018
(86) PCT No.: PCT/JP2018/021291

§ 371 Date: Apr. 10, 2020

(30) Foreign Application Priority Data
Oct. 11, 2017 (JP) 2017-198065

(51) Int. Cl. C08G 73/10; C08J 5/18

(52) U.S. Cl. CPC C08G 73/1078; C08G 73/1007; C08J 5/18; C08G 73/1042; C08G 73/1064; C08G 73/1039

(57) ABSTRACT

A polyimide has structures derived from acid dianhydrides and structures derived from diamines. The polyimide of the present invention contains, at a ratio in a predetermined range, an alicyclic acid dianhydride and a fluorine-containing aromatic acid dianhydride as acid dianhydrides, and contains, at a ratio in a predetermined range, 3,3′-diaminodiphenyl sulfone and a fluoroalkyl-substituted benzidine as diamines. The polyimide of the present invention has an excellent solubility in a solvent. Further, the polyimide of the present invention has less coloration, an excellent transparency, and an excellent mechanical strength.

### TECHNICAL FIELD

The present invention relates to a polyimide resin and a production method for the polyimide resin, a polyimide solution, and a polyimide film and a production method for the polyimide film.

### TECHNICAL BACKGROUND

Along with rapid progresses in electronic devices such as displays, touch panels and solar cells, there are increasing demands for reduction in thickness and weight and increase in flexibility of the devices. In response to these demands, replacement of glass materials used for substrates or cover windows with plastic film materials has been studied. In particular, for applications requiring a high heat resistance, a high dimensional stability at a high temperature, and a high mechanical strength, application of a polyimide film as an alternative material for glass has been studied.

A general wholly aromatic polyimide is colored yellow or brown and does not exhibit solubility with respect to an organic solvent. As methods for imparting visible light transparency and solvent solubility to a polyimide, introduction of an alicyclic structure, introduction of a bent structure, introduction of a fluorine substituent, and the like are known (for example, Patent Document 1).

A polyimide film is generally produced using a method in which a polyamic acid solution which is a polyimide precursor is applied in a form of a film onto a substrate, and the solvent is removed by heating, and the polyamic acid is imidized by cyclodehydration. In production of a polyimide film, when imidization of a polyamic acid is performed together with film formation, an imidization catalyst and a dehydrating agent for the imidization, water generated by dehydration of the polyamic acid, and the like are likely to remain in the film. In thermal imidization in which an imidization catalyst or a dehydrating agent is not used, a heat treatment at a high temperature is required for imidization, and thus, a film tends to be colored yellow and transparency tends to be reduced. Further, even in thermal imidization, it is not easy to completely remove water generated by dehydration of the polyamic acid. An imidization catalyst, a dehydrating agent, water, or the like remaining in a film may cause defects such as voids, and may reduce mechanical strength or toughness of the film.

For a soluble polyimide, a film can also be produced using a method in which a polyimide resin solution is applied onto a substrate and the solvent is removed. For example, Patent Document 2 discloses an example in which a film is produced using a polyimide resin obtained from 2,2′-bis(trifluoromethyl) benzidine (TFMB) and 2,2-bis(3,4-dicarboxyphenyl) hexafluoropropane dianhydride (6FDA).

When a polyimide film is produced using a polyimide resin solution, first, an imidization catalyst and a dehydrating agent are added to a polyamic acid solution, which is obtained by a reaction between a diamine and an acid dianhydride, to perform imidization in the solution, and thereafter, the solution is mixed with a poor solvent, and thereby, a polyimide resin is precipitated and isolated. In the isolated polyimide resin, residual amounts of the imidization catalyst and the dehydrating agent or unreacted monomer components or the like are small. Further, by washing the resin after isolation, impurities can be further reduced. After a solution obtained by dissolving the isolated polyimide resin in a solvent is applied in a form of a film onto a substrate, it is only necessary to remove the solvent without the need for high-temperature heating for imidization. Therefore, a polyimide film having less coloration and an excellent transparency can be obtained.

### RELATED ART

### Patent Documents

Patent Document 1: WO 2015/125895

Patent Document 2: Japanese Patent Application Laid-Open Publication No. 2012-146905.

### SUMMARY OF THE INVENTION

Problems to be Solved by the Invention

As described above, in order to obtain a polyimide film having a high transparency, a method is suitable in which imidization is performed in a solution and then film formation is performed using an isolated polyimide resin. However, the polyimide formed of a fluorine-containing aromatic diamine component and a fluorine-containing aromatic acid dianhydride component described in Patent Document 2 has insufficient mechanical strength, and its use is limited.

Patent Document 1 discloses examples of producing various transparent polyimide films. However, in all the examples, imidization is performed after a polyamic acid solution is applied onto a substrate, and no example is given in which a polyimide resin is isolated by performing imidization in a solution. The present investigator synthesized polyamic acids of compositions disclosed in Patent Document 1 and attempted chemical imidization in solutions. However, for most of the compositions, gelation or solidification occurred and a polyimide resin could not be isolated. Further, for a composition for which a polyimide resin could be isolated, the polyimide resin had insufficient mechanical strength when formed into a film.

In general, there is a trade-off relationship between solubility and mechanical strength of a polyimide. A polyimide that can be isolated without causing gelation or solidification during imidization in a solution often has insufficient mechanical strength. In view of such a problem, the present invention is intended to provide a polyimide resin that has a high solubility in a solvent, can be imidized in a solution, has less coloration, and is excellent in transparency and mechanical strength.

### Means for Solving the Problems

A polyimide of the present invention contains, as acid dianhydride components, an alicyclic acid dianhydride and a fluorine-containing aromatic acid dianhydride in a total amount of 70 mol % or more with respect to a total amount of 100 mol % of the acid dianhydrides, and contains, as diamine components, 3,3′-diaminodiphenyl sulfone and a fluoroalkyl-substituted benzidine in a total amount of 70 mol % or more with respect to a total amount of 100 mol % of the diamines.

As the alicyclic acid dianhydride, 1,2,3,4-cyclobutanetetracarboxylic acid dianhydride, 1,2,3,4-cyclopentanetetracarboxylic acid dianhydride, 1,2,4,5-cyclohexanetetracarboxylic acid dianhydride, and the like are preferably used. As the fluorine-containing aromatic acid dianhydride, 2,2-bis(3,4-dicarboxyphenyl)-1,1,1,3,3,3-hexafluoropropane dianhydride is preferably used. As the fluoroalkyl-substituted benzidine, a fluoromethyl-substituted benzidine such as 2,2′-bis(trifluoromethyl) benzidine is preferably used.

In the polyimide of the present invention, a content (x) of the 3,3′-diaminodiphenyl sulfone with respect to a total amount of 100 mol % of the 3,3′-diaminodiphenyl sulfone and the fluoroalkyl-substituted benzidine and a content (y) of the alicyclic acid dianhydride with respect to a total amount of 100 mol % of the alicyclic acid dianhydride and the fluorine-containing aromatic acid dianhydride satisfy the following relations:
10≤x≤90,
15≤y≤95,
y≤0.4x+70,
y≤1.8x+20, and
y−x≤−50.

The polyimide of the present invention preferably contains 20-60 mol % of the 3,3′-diaminodiphenyl sulfone with respect to a total amount of 100 mol % of the diamine components. The polyimide of the present invention preferably contains 35-80 mol % of the 1,2,3,4-cyclobutanetetracarboxylic acid dianhydride with respect to a total amount of 100 mol % of the acid dianhydride components.

A polyamic acid is obtained by causing the diamines and the acid dianhydrides of the above compositions to react with each other, and a polyimide is obtained by subjecting the polyamic acid to cyclodehydration. For the polyimide of the present invention, in addition to that the polyimide resin itself is solvent soluble, gelation or solidification during imidization in a solution is unlikely to occur, and an imidization reaction can be performed in a solution. In one embodiment of the present invention, a polyamic acid solution is prepared by causing a diamine and an acid dianhydride to react with each other in a solvent, and, by adding a dehydrating agent and an imidization catalyst to the polyamic acid solution, imidization in the solution is performed. By mixing the solution after imidization with a poor solvent for a polyimide, it is possible to precipitate and isolate a polyimide resin.

The present invention relates to a polyimide solution obtained by dissolving the above polyimide resin in a solvent, and a film containing the above polyimide resin. The polyimide film of the present invention can be obtained by applying the polyimide solution onto a substrate and removing the solvent.

The film of the present invention preferably has a yellowness of 3.0 or less, a tensile elastic modulus of 3.5 GPa or more, a pencil hardness of 4H or more, a light transmittance of 70% or more at a wavelength of 400 nm, and a glass transition temperature of 300° C. or higher.

### Effect of Invention

The polyimide of the present invention has excellent solubility. Gelation or solidification is unlikely to occur during imidization in a solution obtained from a polyamic acid. Therefore, a polyimide resin having less impurities can be easily isolated. By dissolving the polyimide resin in a solvent to form a film, a polyimide film having a high transparency can be obtained. Further, the polyimide of the present invention can achieve both good transparency and good mechanical strength, and thus, can be used as a substrate material for a display or as a cover window material, or the like.

### BRIEF DESCRIPTION OF DRAWINGS

FIG. 1 is a diagram describing ratios of an acid dianhydride component and a diamine in a polyimide resin.

### MODE FOR CARRYING OUT THE INVENTION

### Composition of Polyimide

A polyimide is generally obtained by subjecting a polyamic acid to cyclodehydration, the polyamic acid being obtained by a reaction between a tetracarboxylic acid dianhydride (hereinafter, may be simply referred to as an “acid dianhydride”) and a diamine. That is, a polyimide has a structure derived from an acid dianhydride and a structure derived from a diamine.

### Acid Dianhydrides

The polyimide of the present invention contains, as acid dianhydride components, an alicyclic acid dianhydride and a fluorine-containing aromatic acid dianhydride.

Examples of the alicyclic acid dianhydride include 1,2,3,4-cyclobutanetetracarboxylic acid dianhydride, 1,2,3,4-cyclopentanetetracarboxylic acid dianhydride, 1,2,4,5-cyclohexanetetracarboxylic acid dianhydride, and 1,1′-bicyclohexane-3,3′,4,4′-tetracarboxylic acid-3,4,3′,4′-dianhydride. Among them, from a point of view allowing a polyimide having excellent transparency and mechanical strength to be obtained, as the alicyclic acid dianhydride, 1,2,3,4-cyclobutanetetracarboxylic acid dianhydride, 1,2,3,4-cyclopentanetetracarboxylic acid dianhydride, or 1,2,4,5-cyclohexanetetracarboxylic acid dianhydride is preferable, and 1,2,3,4-cyclobutanetetracarboxylic acid dianhydride is particularly preferable.

Examples of the fluorine-containing aromatic acid dianhydride include 2,2-bis(3,4-dicarboxyphenyl)-1,1,1,3,3,3-hexafluoropropane dianhydride, 2,2-bis{4-[4-(1,2-dicarboxy) phenoxy] phenyl}-1,1,1,3,3,3-hexafluoropropane dianhydride, and the like. By using the fluorine-containing aromatic acid dianhydride as an acid dianhydride component in addition to the alicyclic acid dianhydride, the transparency and the solubility of the polyimide tend to be improved, and it is particularly effective for suppressing gelation during imidization in a solution.

The polyimide of the present invention may also contain, as an acid dianhydride component, a component other than the alicyclic acid dianhydride and the fluorine-containing aromatic acid dianhydride. Examples of acid dianhydrides other than the alicyclic acid dianhydride and the fluorine-containing aromatic acid dianhydride include aromatic tetracarboxylic acid dianhydrides having four carbonyls bonded to one aromatic ring, such as pyromellitic acid dianhydride, 1,2,5,6-naphthalenetetracarboxylic acid dianhydride, and 2,3,6,7-naphthalenetetracarboxylic acid dianhydride; and aromatic tetracarboxylic acid dianhydrides having two carbonyl groups bonded to each of different aromatic rings, such as 2,2-bis[4-(3,4-dicarboxyphenoxy) phenyl] propane dianhydride, 2,2-bis[4-(3,4-dicarboxyphenoxy) phenyl] hexafluoropropane dianhydride, 2,2-bis(4-hydroxyphenyl) propane dibenzoate-3,3′,4,4′-tetracarboxylic acid dianhydride, 3,3′,4,4′-biphenyl-tetracarboxylic acid dianhydride, 2,3,3′,4′-biphenyl-tetracarboxylic acid dianhydride, 4,4′-(hexafluoroisopropylidene) diphthalic acid anhydride, 3,3′,4,4′-benzophenonetetracarboxylic acid dianhydride, 3,4′-oxydiphthalic acid anhydride, 4,4′-oxydiphthalic acid anhydride, and 3,3′,4,4′-diphenylsulfonetetracarboxylic acid dianhydride.

When a component other than the alicyclic acid dianhydride and the fluorine-containing aromatic acid dianhydride is used as an acid dianhydride component, from a point of view of the solubility and the transparency of the polyimide, an aromatic tetracarboxylic acid dianhydride having two carbonyl groups bonded to each of different aromatic rings is preferably used. By using an aromatic tetracarboxylic dianhydride having two carbonyl groups bonded to each of different aromatic rings as an acid dianhydride component in addition to the alicyclic acid dianhydride and the fluorine-containing aromatic acid dianhydride, in some cases, the heat resistance or the mechanical strength of the polyimide can be improved without impairing the transparency and the solubility of the polyimide. In particular, from a point of view of maintaining the mechanical strength of the polyimide, as an acid dianhydride other than the alicyclic acid dianhydride and the fluorine-containing aromatic acid dianhydride, an acid dianhydride having a biphenyl skeleton such as 3,3′,4,4′-biphenyl-tetracarboxylic acid dianhydride is preferable.

From a point of view of the transparency, the solubility and the mechanical strength of the polyimide, in a total amount of 100 mol % of the acid dianhydride components, a total amount of the alicyclic acid dianhydride and the fluorine-containing aromatic acid dianhydride is preferably 70 mol % or more, more preferably 80 mol % or more, even more preferably 85 mol % or more, and particularly preferably 90 mol % or more. Among them, a total amount of the 1,2,3,4-cyclobutanetetracarboxylic acid dianhydride and the 2,2-bis(3,4-dicarboxyphenyl)-1,1,1,3,3,3-hexafluoropropane dianhydride is preferably within the above range.

### Diamine

The polyimide of the present invention contains, as diamine components, a fluoroalkyl-substituted benzidine (which is a fluorine-containing aromatic diamine) and 3,3′-diaminodiphenyl sulfone (hereinafter, referred to as “3,3′-DDS”) (which is a sulfonyl group-containing diamine).

In general, by using, as a diamine component, a fluorine-containing aromatic diamine or a diamine having a bent structure, the solubility of the polyimide tends to be improved. Among them, the 3,3′-DDS contributes greatly to an improvement in the solubility. In the present invention, by using the fluoroalkyl-substituted benzidine (which is a fluorine-containing aromatic diamine) and the 3,3′-DDS (which is a diamine having a bent structure) in combination as diamine components, a polyimide having a high mechanical strength and excellent transparency and solubility can be obtained.

The fluoroalkyl-substituted benzidine has a fluoroalkyl group on one or both benzene rings of 4,4′-diaminobiphenyl. The fluoroalkyl-substituted benzidine may have multiple fluoroalkyl groups on one benzene ring. As a fluoroalkyl group, a trifluoromethyl group is preferable. Specific examples of trifluoromethyl-substituted benzidines include trifluoromethyl-substituted benzidines having one or more trifluoromethyl groups on one of benzene rings, such as 2-(trifluoromethyl) benzidine, 3-(trifluoromethyl) benzidine, 2,3-bis(trifluoromethyl) benzidine, 2,5-bis(trifluoromethyl) benzidine, 2,6-bis(trifluoromethyl) benzidine, 2,3,5-tris(trifluoromethyl) benzidine, 2,3,6-tris(trifluoromethyl) benzidine, and 2,3,5,6-tetrakis(trifluoromethyl) benzidine; and trifluoromethyl-substituted benzidines having one or more trifluoromethyl groups on each of two benzene rings, such as 2,2′-bis(trifluoromethyl) benzidine, 3,3′-bis(trifluoromethyl) benzidine, 2,3′-bis(trifluoromethyl) benzidine, 2,2′,3-tris(trifluoromethyl) benzidine, 2,3,3′-tris(trifluoromethyl) benzidine, 2,2′,5-tris(trifluoromethyl) benzidine, 2,2′,6-tris(trifluoromethyl) benzidine, 2,3′,5-tris(trifluoromethyl) benzidine, 2,3′,6,-tris(trifluoromethyl) benzidine, 2,2′,3,3′-tetrakis(trifluoromethyl) benzidine, 2,2′,5,5′-tetrakis(trifluoromethyl) benzidine, and 2,2′,6,6′-tetrakis(trifluoromethyl) benzidine.

Among them, a trifluoromethyl-substituted benzidine having one or more trifluoromethyl groups on each of two benzene rings is preferable, and 2,2′-bis(trifluoromethyl) benzidine, or 3,3′-bis(trifluoromethyl) benzidine is particularly preferable. From a point of view of the solubility, the transparency and the like of the polyimide, the 2,2′-bis(trifluoromethyl) benzidine is particularly preferable.

The polyimide of the present invention may have, as a structure derived from a diamine, a structure derived from a diamine other than those described above. Examples of diamines other than those described above include: fluorine-containing aromatic diamines other than fluoroalkyl-substituted benzidines; sulfonyl group-containing diamines other than the 3,3′-DDS; diamines having two amino groups bonded to one aromatic ring, such as p-phenylenediamine, m-phenylenediamine, and o-phenylenediamine; aromatic diamines having an amino group bonded to each of different aromatic rings, such as diaminodiphenyl ether, diaminodiphenyl sulfide, diaminobenzophenone, diaminodiphenylalkane, and bis(aminobenzoyl) benzene; and alicyclic diamines such as diaminocyclohexane, and isophoronediamine.

From a point of view of the transparency, the solubility and the mechanical strength of the polyimide, in a total amount of 100 mol % of the diamine components, a total amount of the fluoroalkyl-substituted benzidine and the 3,3′-DDS is preferably 70 mol % or more, more preferably 80 mol % or more, even more preferably 85 mol % or more, and particularly preferably 90 mol % or more. Among them, a total amount of the 2,2′-bis(trifluoromethyl) benzidine and the 3,3′-DDS is preferably within the above range.

### Compositions of Diamines and Acid Dianhydrides

As described above, the polyimide of the present invention contains the 3,3′-DDS and the fluoroalkyl-substituted benzidine as diamine components, and contains the alicyclic acid dianhydride and the fluorine-containing aromatic acid dianhydride as acid dianhydride components. From a point of view of the transparency and the solubility of the polyimide, a total amount of the 3,3′-DDS and the fluoroalkyl-substituted benzidine with respect to a total amount of 100 mol % of the diamines is preferably 70 mol % or more, and a total amount of the alicyclic acid dianhydride and the fluorine-containing aromatic acid dianhydride with respect to a total amount of 100 mol % of the acid dianhydrides is preferably 70 mol % or more.

Further, the polyimide of the present invention is characterized in that ratios of the 3,3′-DDS and the fluoroalkyl-substituted benzidine in the diamine components and ratios of the alicyclic acid dianhydride and the fluorine-containing aromatic acid dianhydride in the acid dianhydride components are in predetermined ranges. Specifically, a content (x) of the 3,3′-DDS with respect to a total amount of 100 mol % of the 3,3′-DDS and the fluoroalkyl-substituted benzidine and a content (y) of the alicyclic acid dianhydride with respect to a total amount of 100 mol % of the alicyclic acid dianhydride and the fluorine-containing aromatic acid dianhydride satisfy the following relations:
10≤x≤90,
15≤y≤95,
y≤0.4x+70,
y≤1.8x+20, and
y−x≥−50.

When x and y are in the above ranges, the polyimide of the present invention can have both good transparency and mechanical strength and good solubility in a solvent.

The solubility of the polyimide refers to solubility during imidization in a solution obtained by cyclodehydration of a polyamic acid, and refers to solubility of the polyimide itself in a solvent. “Having solubility during imidization” means that solid substances and turbidity do not occur when imidization is performed by adding a dehydrating agent and an imidization catalyst or the like to a polyamide acid solution. The “solubility of the polyimide itself” means that solid substances and turbidity do not occur when the polyimide resin is dissolved in a solvent used in preparation of a solution (dope) for film formation. A soluble polyimide has the above characteristics when solid content concentrations of a polyamic acid solution and a polyimide solution are preferably 10 weight % or more, more preferably 15 weight % or more, and even more preferably 20 weight % or more.

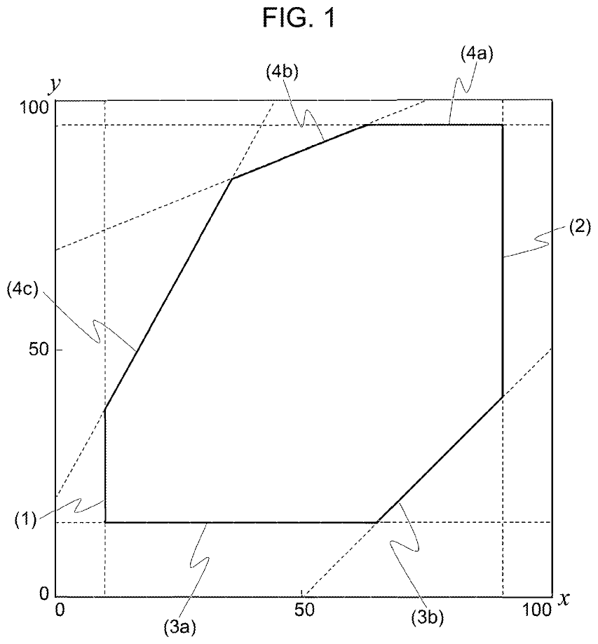

FIG. 1 shows on a xy plane ranges of x and y satisfying the above formulas. In FIG. 1, the ranges satisfying the above formulas are within a region surrounded by the following seven lines:
(1) x≥10,
(2) x≤90,
(3a) y≥15,
(3b) y≥x−50,
(4a) y≤95,
(4b) y≤0.4x+70, and
(4c) y≤1.8x+20.

When only the fluorine-containing aromatic acid dianhydride is contained as an acid dianhydride (y=0), the polyimide exhibits a high solubility even when only the fluoroalkyl-substituted benzidine is used as a diamine (x=0) (for example, the above-described Patent Document 2). However, a polyimide containing only the fluorine-containing aromatic acid dianhydride as an acid dianhydride component has insufficient mechanical strength. In order to obtain a polyimide having excellent mechanical strength, the polyimide of the present invention contains the alicyclic acid dianhydride as an acid dianhydride component.

When a content of the alicyclic acid dianhydride is 15 mol % or more with respect to a total amount of the alicyclic acid dianhydride and the fluorine-containing aromatic acid dianhydride, the mechanical strength of the polyimide is increased (the formula (3a)). On the other hand, when the ratio of the alicyclic acid dianhydride is increased, when imidization is performed by adding a dehydrating agent and an imidization catalyst to a polyamic acid solution, viscosity of the solution rapidly increases and gelation or solidification occurs, and it may become difficult to obtain a polyimide resin. Therefore, the content of the alicyclic acid dianhydride is 95 mol % or less with respect to the total amount of the alicyclic acid dianhydride and the fluorine-containing aromatic acid dianhydride (the formula (4a)). In other words, the content of the fluorine-containing aromatic acid dianhydride with respect to the total amount of the alicyclic acid dianhydride and the fluorine-containing aromatic acid dianhydride is 5 mol % or more.

When the alicyclic acid dianhydride is used as an acid dianhydride in addition to the fluorine-containing aromatic acid dianhydride, as compared to a case where only the fluorine-containing aromatic acid dianhydride is used as an acid dianhydride, the polyimide has low solubility, and, when only the fluoroalkyl-substituted benzidine is used as a diamine, gelation or solidification occurs during imidization of a polyamic acid solution. By using the 3,3′-DDS as a diamine in addition to the fluoroalkyl-substituted benzidine, gelation or solidification can be suppressed. A content of the 3,3′-DDS with respect to a total amount of the 3,3′-DDS and the fluoroalkyl-substituted benzidine is 10 mol % or more (the formula (1)).

As the ratio of the 3,3′-DDS increases, the solubility of the polyimide tends to increase. On the other hand, the mechanical strength tends to decrease. Further, when the ratio of the3,3′-DDS is large, it is possible that the polyimide is colored yellow and the transparency is reduced. From a point of view of maintaining the effect of improving the mechanical strength by using the alicyclic acid dianhydride and obtaining a polyimide having an excellent transparency, the content of the 3,3′-DDS with respect to the total amount of the 3,3′-DDS and the fluoroalkyl-substituted benzidine is 90 mol % or less (the formula (2)). In other words, the content of the fluoroalkyl-substituted benzidine with respect to the total amount of the 3,3′-DDS and the fluoroalkyl-substituted benzidine is 10 mol % or more.

As described above, in order to increase the mechanical strength of the polyimide and to prevent gelation or solidification during imidization from a polyamic acid solution, x is in a range of 10-90, and y is in a range of 15-95. x is preferably 15-70, more preferably 20-60, and even more preferably 25-50. y is preferably 30-90, more preferably 45-85, and even more preferably 50-80.

From a point of view of increasing the mechanical strength of the polyimide, it is preferable to increase the ratio of the alicyclic acid dianhydride and the ratio of the fluoroalkyl-substituted benzidine. That is, when y is increased and x is decreased, the mechanical strength of the polyimide tends to be improved. In order to obtain a polyimide having a high mechanical strength (for example, a film produced from the polyimide resin has a pencil hardness of 2H or more), x and y are required to satisfy y≥x−50 (the formula (3b)). That is, the polyimide of the present invention satisfies y≥15 (the above-described formula (3a), and y≥x−50 (the formula (3b)), and thus, has excellent mechanical strength.

For a larger value of (y−x), the mechanical strength of the polyimide tends to be higher. The value of (y−x) is preferably −25 or more, more preferably −20 or more, even more preferably −15 or more, and particularly preferably −10 or more. In particular, in order to obtain a polyimide film having a pencil hardness of 4H or more, (y−x) is preferably 0 or more (that is, y≥x), more preferably 5 or more, even more preferably 10 or more, even more preferably 15 or more, and particularly preferably 20 or more.

From a point of view of increasing the mechanical strength of the polyimide, (y−x) is preferably large, and when x and y are in an upper-left region in FIG. 1, the mechanical strength of the polyimide tends to increase. On the other hand, when y is large (the ratio of the alicyclic acid dianhydride component is large) and x is small (the ratio of the 3,3′-DDS is small), the solubility of the polyimide is low and, in particular, gelation or solidification during imidization of the polyamic acid solution is likely to occur.

When the ratio of the 3,3′-DDS is large and x is larger than 60, when y≤95 (the formula (4a)), gelation during imidization from a polyamic acid does not occur and a soluble polyimide can be obtained. On the other hand, when the ratio (x) of the 3,3′-DDS is set to 60 or less in order to increase the mechanical strength of the polyimide, the solubility of the polyimide tends to rapidly decrease, and, in order to prevent gelation during imidization, it is necessary to reduce y (the ratio of the alicyclic acid dianhydride) as x (the ratio of the 3,3′-DDS) decreases. The formula (4b) shows a range in which a polyimide can be obtained without occurrence of gelation when x is about 60 or less. When x is further reduced, the solubility of the polyimide becomes more sensitive to a change in the ratio (y) of the alicyclic acid dianhydride. The formula (4c) shows a range in which a polyimide can be obtained without occurrence of gelation when x is about 35 or less.

That is, the formula (4c) shows the range in which gelation during imidization can be prevented when xis in the range of about 10-35; the formula (4b) shows the range in which gelation during imidization can be prevented when xis in the range of about 35-60; and the formula (4a) shows the range in which gelation during imidization can be prevented when x is in the range of 60 or more. Since x and y satisfy the formulas (4a), (4b) and (4c), the polyimide of the present invention has excellent solubility in an organic solvent, and gelation or solidification during imidization from a polyimide acid solution is unlikely to occur.

As described above, when the ratio of the alicyclic acid dianhydride is larger, the mechanical strength of the polyimide tends to be higher. Therefore, from a point of view of obtaining a polyimide having a high mechanical strength, a larger y is preferable as long as y is in a range in which the formulas (4a), (4b) and (4c) are satisfied, and x and y are preferably in vicinities of straight lines represented by these formulas. On the other hand, in the vicinities of the formulas (4a), (4b) and (4c), although gelation or solidification can be prevented, the viscosity of the solution may rapidly increase during imidization. Therefore, in order to obtain a polyimide having a higher solubility, as described above, y is preferably 90 or less, more preferably 85 or less, and even more preferably 80 or less. From the same point of view, x and y preferably satisfy y≤0.4x+65. Further, x and y preferably satisfy y≤1.8x+15.

As described above, the polyimide of the present invention exhibits a high mechanical strength by containing the alicyclic acid dianhydride as an acid dianhydride component in addition to the fluorine-containing aromatic acid dianhydride, and can ensure solubility by containing the 3,3′-DDS as a diamine component in addition to the fluoroalkyl-substituted benzidine. By setting the ratios (x, y) of the acid dianhydrides and the diamine within predetermined ranges, the mechanical strength of the polyimide can be further increased while maintaining the solubility and preventing gelation or solidification during imidization.

From a point of view of allowing the polyimide to achieve both good mechanical strength and good solubility, a content of the alicyclic acid dianhydride with respect to a total amount of 100 mol % of the acid dianhydrides is preferably 35-80 mol %, more preferably 40-75 mol %, and even more preferably 45-70 mol %. In particular, a content of the 1,2,3,4-cyclobutanetetracarboxylic acid dianhydride with respect to a total amount of 100 mol % of the acid dianhydrides is preferably 35-80 mol %, more preferably 40-75 mol %, and even more preferably 45-70 mol %.

From a point of view of allowing the polyimide to achieve both good mechanical strength and good solubility, a content of the 3,3′-DDS with respect to a total amount of 100 mol % of the diamines is preferably 20-60 mol %, and even more preferably 25-50 mol %.

### Preparation of Polyimide Resin

### Polyamic Acid

As described above, the polyimide is obtained by cyclodehydration of a polyimide acid which is a polyimide precursor. A polyamic acid can be obtained, for example, by causing an acid dianhydride and a diamine to react with each other in an organic solvent. The acid dianhydride and the diamine are preferably used at substantially equimolar amounts (a molar ratio in a range of 95:100-105:100). In order to suppress ring opening of the acid dianhydride, a method is preferable in which the diamine is dissolved in a solvent and then the acid dianhydride is added. When multiple kinds of diamines or multiple kinds of acid dianhydrides are added, the addition may be performed at once or may be added in multiple times. A polyamic acid solution is usually obtained at a concentration of 5-35 weight %, preferably 10-30 weight %.

In polymerization of a polyamic acid, an organic solvent that cab dissolve a diamine and an acid dianhydride as raw materials and can dissolve the polyamic acid as a polymerization product can be used without particular limitation. Specific examples of the organic solvent include: urea-based solvents such as methyl urea, and N,N-dimethylethyl urea; sulfone-based solvents such as dimethyl sulfoxide, diphenyl sulfone, and tetramethyl sulfone; amide-based solvents such as N,N-dimethylacetamide, N,N-dimethylformamide, N,N′-diethylacetamide, N-methyl-2-pyrrolidone, y-butyrolactone, and hexamethylphosphoric triamide; alkyl halide-based solvents such as chloroform and methylene chloride; aromatic hydrocarbon-based solvents such as benzene and toluene; and ether-based solvents such as tetrahydrofuran, 1,3-dioxolan, 1,4-dioxane, dimethyl ether, diethyl ether and p-cresol methyl ether. Among them, from a point of view of being excellent in polymerization reactivity and polyamic acid solubility, dimethylacetamide, dimethylformamide, or N-methylpyrrolidone is preferably used.

### Imidization

A polyimide is obtained by cyclodehydration of a polyamic acid. For imidization in a solution, a chemical imidization method is suitable in which a dehydrating agent and an imidization catalyst are added to a polyamic acid solution. In order to promote progress of the imidization, the polyamic acid solution may be heated.

Tertiary amines are used as imidization catalysts. Among them, heterocyclic tertiary amines such as pyridine, picoline, quinoline and isoquinoline are preferable. Acid anhydrides such as acetic anhydride, propionic acid anhydride, butyric acid anhydride, benzoic acid anhydride and trifluoroacetic acid anhydride are used as dehydrating agents. An additive amount of an imidization catalyst with respect to an amide group of a polyamic acid is preferably 0.5-5.0 molar equivalents, more preferably 0.6-2.5 molar equivalents, and even more preferably 0.7-2.0 molar equivalents. An additive amount of a dehydrating agent with respect to an amide group of a polyamic acid is preferably 0.5-10.0 molar equivalents, more preferably 0.7-7.0 molar equivalents, and even more preferably 1.0-5.0 molar equivalents.

In imidization of a polyamic acid by cyclodehydration, a nitrogen atom of amide is nucleophilic to a carbonyl carbon of a carboxylic acid, and thereby, one molecule of water is eliminated with formation of one C—N bond. An intermediate of this reaction has a lower solubility than a polyimide which is a reaction product. Therefore, even when a polyamic acid and a polyimide exhibit solubility with respect to a solvent, when an accumulated amount of a reaction intermediate during imidization increases, an increase in viscosity or gelation may occur. Therefore, even when a polyimide exhibits solubility with respect to a solvent, imidization in a solution may be difficult depending on a composition. In the present invention, by using predetermined acid dianhydrides and diamines at ratios in predetermined ranges (the ranges of x and y described above), in addition to that the polyimide itself exhibits a high solubility with respect to a solvent, gelation due to a rapid increase in viscosity during imidization can be prevented.

### Precipitation of Polyimide Resin

Although a polyimide solution obtained by imidization of a polyamic acid can be used as it is as a film-forming dope, it is preferable that a polyimide resin is once precipitated as a solid. By precipitating a polyimide resin as a solid, impurities generated during polymerization of the polyamic acid, and remaining monomer components, dehydrating agent and imidization catalyst and the like can be removed by washing. Therefore, a polyimide film having excellent transparency and mechanical characteristics can be obtained.

By mixing the polyimide solution with a poor solvent, a polyimide resin precipitates. The poor solvent is a poor solvent for the polyimide resin and is preferably miscible with a solvent in which the polyimide resin is dissolved, and examples thereof include water, alcohols, and the like. Examples of alcohols include methyl alcohol, ethyl alcohol, isopropyl alcohol, ethylene glycol, triethylene glycol, 2-butyl alcohol, 2-hexyl alcohol, cyclopentyl alcohol, cyclohexyl alcohol, phenol, t-butyl alcohol, and the like. From a point of view that ring-opening or the like of a polyimide is unlikely to occur, alcohols such as isopropyl alcohol, 2-butyl alcohol, 2-pentyl alcohol, phenol, cyclopentyl alcohol, cyclohexyl alcohol and t-butyl alcohol are preferable, and isopropyl alcohol is particularly preferable.

Prior to mixing the polyimide resin solution with a poor solvent, a solid content concentration of the polyimide solution may be adjusted. The solid content concentration of the polyimide solution is preferably about 3-30 weight %. Methods for mixing a polyimide resin solution with a poor solvent include a method in which a polyimide solution is put into a poor solvent solution, a method in which a poor solvent is put into a polyimide solution, a method in which a poor solvent and a polyimide solution are simultaneously mixed, and the like. An amount of the poor solvent is preferably equal to or more than an amount of the polyimide resin solution, more preferably 1.5 or more times (in volume) the amount of the polyimide resin solution, and even more preferably 2 or more times (in volume) the amount of the polyimide resin solution.

Since a small amount of the imidization catalyst, the dehydrating agent or the like may remain in the precipitated polyimide resin, it is preferable to perform washing with a poor solvent. The poor solvent is preferably removed by vacuum drying, hot air drying, or the like from the polyimide resin after precipitation and washing. A drying method may be vacuum drying or hot air drying. A drying condition may be appropriately set according to the type of the solvent and the like. A polyimide resin solid substance is a solid substance that can include various forms such as a powdery form and a flake form, and an average particle size thereof is preferably 5 mm or less, more preferably 3 mm or less, and particularly preferably 1 mm or less.

A weight average molecular weight of the polyimide is preferably 5,000-500,000, more preferably 10,000-300,000, and even more preferably 30,000-200,000. When the weight average molecular weight is within this range, sufficient mechanical characteristics can be easily obtained. The molecular weight in the present specification is a value of polyethylene oxide (PEO) conversion by gel permeation chromatography (GPC). The molecular weight can be adjusted by a molar ratio of a diamine to an acid dianhydride or a reaction condition, or the like.

### Polyimide Solution

A polyimide solution is prepared by dissolving the above polyimide resin in an appropriate solvent. The solvent is not particularly limited as long as the solvent can dissolve the above polyimide resin, and examples thereof include solvents such the urea-based solvents, sulfone-based solvents, amide-based solvents, alkyl halide-based solvents, aromatic hydrocarbon-based solvents, and ether-based solvents exemplified above as examples of an organic solvent used for polymerization of a polyamic acid. In addition to these solvents, ketone-based solvents such as acetone, methyl ethyl ketone, methyl propyl ketone, methyl isopropyl ketone, methyl isobutyl ketone, diethyl ketone, cyclopentanone, cyclohexanone and methylcyclohexanone can also be suitably used as solvents for the polyimide resin composition.

Among these solvents, amide-based solvents, aromatic hydrocarbon-based solvents, or ketone-based solvents are preferable. Among them, from a point of view of having a low boiling point and allowing production efficiency of a polyimide film to be improved, the ketone-based solvents are preferable. In the polyimide solution, with respect to a total solvent amount of 100 parts by weight, a ketone-based solvent is preferably 50 or more parts by weight, more preferably 70 or more parts by weight, and even more preferably 80 or more parts by weight. The polyimide resin of the present invention has a high solubility, and thus, also exhibits a high solubility with respect to a ketone-based solvent.

The polyimide solution may contain a resin component other than a polyimide or additives. Examples of the additives include a cross-linking agent, a dye, a surfactant, a leveling agent, a plasticizer, fine particles, and the like. A content of the polyimide resin with respect to 100 parts by weight of a solid content of the polyimide resin composition is preferably 60 or more parts by weight, more preferably 70 or more parts by weight, and even more preferably 80 or more parts by weight.

A solid content concentration and viscosity of the polyimide solution may be appropriately set according to a molecular weight of the polyimide, a thickness of a film, a film forming environment, or the like. The solid content concentration is preferably 5-30 weight %, more preferably 8-25 weight %, and even more preferably 10-21 weight %. The viscosity at 25° C. is preferably 0.5 Pa·s -60 Pa·s, more preferably 2 Pa·s-50 Pa·s, and even more preferably 5 Pa·s-40 Pa·s.

### Polyimide Film

### Production Method for Polyimide Film

Methods for producing a polyimide film include a method in which a polyamic acid solution is applied in a form of a film onto a substrate and the solvent is removed by drying and the polyamic acid is imidized, and a method in which a polyimide resin solution is applied in a form of a film onto a substrate and the solvent is removed by drying. Since the polyimide resin of the present invention is soluble, any one of the methods can be adopted. From a point of view of obtaining a polyimide film having less residual impurities, a high transparency and an excellent mechanical strength, the latter method is preferable. In the latter method, the above polyimide solution is used.

A thickness of a polyimide film is not particularly limited and may be appropriately set according to an intended use. The thickness of the polyimide film is, for example, 5 μm or more. From a point of view of allowing a polyimide film after being peeled off from a support to have a self-supporting property, the thickness of the polyimide film is preferably 20 μm or more, more preferably 25 μm or more, and even more preferably 30 μm or more. In applications for which sufficient strength is required, such as a cover window material for a display, the thickness of the polyimide film may be 40 μm or more, or 50 μm or more. Although an upper limit for the thickness of the polyimide film is not particularly limited, from a point of view of flexibility and transparency, the upper limit is preferably 200 μm or less, more preferably 150 μm or less, and even more preferably 100 μm or less.

As a support onto which a film-forming dope is applied, a glass substrate, a metal substrate such as an SUS substrate, a metal drum, a metal belt, a plastic film, or the like can be used. From a point of view of improving productivity, it is preferable to produce a film by roll-to-roll using, as the support, an endless support such as a metal drum or a metal belt, or a long plastic film, or the like. When a plastic film is used as the support, a material that does not dissolve in the solvent for the film-forming dope may be appropriately selected. As the plastic material, polyethylene terephthalate, polycarbonate, polyacrylate, polyethylene naphthalate or the like can be used.

A polyimide film is obtained by applying the polyimide resin composition onto a support and removing the solvent by drying. Heating is preferably performed during drying of the solvent. A heating temperature is not particularly limited, and is appropriately set in a range of from a room temperature to about 250° C. The heating temperature may be increased stepwise.

### Characteristics of Polyimide Film

A polyimide film used for a display or the like preferably has a low yellowness (YI). The yellowness of the polyimide film is preferably 3.0 or less, more preferably 2.5 or less, even more preferably 2.0 or less, and particularly preferably 1.5 or less. A light transmittance of the polyimide film at a wavelength of 400 m is preferably 70% or more, more preferably 75% or more, even more preferably 80% or more, and particularly preferably 85% or more. An absorbance (A₄₀₀) of the polyimide film per 100 μm in thickness at a wavelength of 400 nm is preferably 0.3 or less, more preferably 0.25 or less, even more preferably 0.2 or less, and particularly preferably 0.15 or less. A total light transmittance of the polyimide film is preferably 85% or more, more preferably 88% or more, and even more preferably 90% or more. A haze of the polyimide film is preferably 1.5% or less, and more preferably 1% or less.

A tensile elastic modulus of the polyimide film is preferably 3 GPa or more, more preferably 3.5 GPa or more, and even more preferably 4 GPa or more. From a point of view of preventing the film from being damaged due to contact with a roll during roll-to-roll carrying or contact between films during winding, a pencil hardness of the polyimide film is preferably 2H or more. When the polyimide film is used for a cover window of a display or the like, the polyimide film is required to be scuff-resistant against an external contact. Therefore, the pencil hardness of the polyimide film is preferably 3H or more, and more preferably 4H or more.

From a point of view of heat resistance, a glass transition temperature of the polyimide film is preferably 200° C. or higher, more preferably 250° C. or higher, and even more preferably 300° C. or higher. The glass transition temperature is a temperature at which a loss tangent reaches a maximum in a dynamic viscoelastic analysis (DMA).

### Applications of Polyimide Film

The polyimide film of the present invention has a low yellowness and a high transparency, and thus, can be suitably used as a material for a display. In particular, the polyimide film having a high mechanical strength can be applied to a surface member such as a cover window of a display. In practical use, an antistatic layer, an easy adhesion layer, a hard coat layer, an anti- reflection layer, and the like may be provided on a surface of the polyimide film of the present invention.

### EXAMPLES

In the following, the present invention is further described in detail based on examples and comparative examples. The present invention is not limited to the following examples.

### Synthesis of Polyamic Acid

138 g of N,N-dimethylformamide (DMF) was charged into a 500 mL separable flask and was stirred under a nitrogen atmosphere. Diamines and acid dianhydrides were added thereto at ratios shown in Table 1, and the mixture was stirred under a nitrogen atmosphere for 5 hours to allow a reaction to proceed, and thereby, a polyamic acid solution having a solid content concentration of 18% was obtained. Abbreviations of the monomers shown in Table 1 are as follows.
CBDA: 1,2,3,4-cyclobutanetetracarboxylic acid dianhydride
PMDA-HS: 1,2,4,5-cyclohexanetetracarboxylic acid dianhydride
6FDA: 2,2-bis(3,4-dicarboxyphenyl) hexafluoropropane dianhydride
BPDA: 3,3′,4,4′-biphenyl-tetracarboxylic acid dianhydride
TFMB: 2,2′-bis (trifluoromethyl) benzidine
3,3′ -DDS: 3,3′ -diaminodiphenyl sulfone
4,4′-DDS: 4,4′-diaminodiphenyl sulfone

### Imidization

35.6 g of pyridine as an imidization catalyst was added to the polyamic acid solution, and, after the pyridine was complete dispersed, 45.9 g of acetic anhydride was added thereto. Thereafter, stirring was continued. For those for which gelation due to a rapid increase in viscosity occurred, the solubility was indicated as “NG,” and for those for which gelation did not occur, the solubility was indicated as “OK.” For those for which the solubility was “OK,” imidization was performed by stirring for 2 hours at 120° C., and then, cooling to a room temperature was performed.

### Precipitation of Polyimide Resin

While the polyimide solution obtained above was stirred, 1 L of isopropyl alcohol (IPA) was added thereto at a rate of 2-3 drops/second to precipitate a polyimide. Thereafter, suction filtration was performed using a Kiriyama funnel and washing was performed using 500 g of IPA. The washing operation was repeated four times and then drying was performed in a vacuum oven set to 120° C. for 12 hours, and a polyimide resin was obtained.

### Production of Polyimide Film

The polyimide resin was dissolved in methyl ethyl ketone and a polyimide solution having a solid content concentration of 17% was obtained. The polyimide solution was applied onto an alkali-free glass plate using a comma coater, and was dried at 40° C. for 10 minutes, at 80° C. for 30 minutes, at 150° C. for 30 minutes and at 170° C. for 1 hour under an air atmosphere, and then, a resulting film was peeled off from the alkali-free glass plate and a polyimide film having a thickness of 30 μm was obtained.

### Imidization and Polyimide Film Preparation of Reference Example 1 and Comparative Example 12

In Reference Example 1 and Comparative Example 12, the polyamic acid solution was applied in a form of a film, and then, the solvent was removed and imidization was performed. 100 g of 3,5-lutidine was added to 100 g of the polyamic acid solution, and then, the mixture was stirred with a glass rod. This solution was applied onto a non-alkali glass plate using a comma coater, and was heated at 40° C. for 10 minutes, at 80° C. for 30 minutes, and at 150° C. for 30 minutes in an air atmosphere. Subsequently, heating was performed under a nitrogen atmosphere using an inert oven, and then, a resulting film was peeled off from the alkali-free glass plate and a polyimide film having a thickness of 30 μm was obtained. The heating condition in the inert oven was 200° C. for 30 minutes and 250° C. for 60 minutes in Reference Example 1, and 200° C. for 30 minutes, 250° C. for 15 minutes and 300° C. for 30 minutes in Comparative Example 12.

### Evaluation of Polyimide Film

The mechanical strength (pencil hardness and tensile elastic modulus), the transparency (yellowness (YI), transmittance, total light transmittance and haze) and the heat resistance (glass transition temperature (Tg)) of the polyimide film were measured according to the following.

### Pencil Hardness

The pencil hardness of the film was measured according to “8.4.1 Pencil Scratch Test” of JIS K-5400-1990.

### Tensile Elastic Modulus

Measurement was performed according to ASTM D882 using AUTOGRAPH AGS-J manufactured by Shimadzu Corporation. (Sample measurement range: width: 15 mm; distance between jaws: 100 mm; tensile speed: 200 mm/min; measurement temperature: 23° C.). Samples moisture-conditioned by being allowed to stand at 23° C. and 55% RH for one week were measured.

### Yellowness

An average value of results measured at 5 places of an 18 cm square sample using HANDY COLORIMETER NR-3000 manufactured by Nippon Denshoku Industries Co., Ltd., was taken as the yellowness of the film.

### Light Transmittance

A transmission spectrum at 200-800 nm of the film was measured using an ultraviolet-visible near-infrared spectrophotometer (V-650) manufactured by JASCO Corporation, and a light transmittance at a wavelength of 400 nm was used as an indicator.

### Total Light Transmittance and Haze

Measurement was performed according to a method described in JIS K7105-1981 using an Integrating sphere type haze meter 300A manufactured by Nippon Denshoku Industries Co., Ltd.

### Glass Transition Temperature

A dynamic viscoelasticity measurement was performed at a measuring jig interval of 20 mm and a frequency of 5 Hz using a DMS-200 manufactured by Seiko Denshi Kogyo Co., Ltd., and a temperature at which a loss tangent (tans) reached a maximum was taken as the glass transition temperature.

Table 1 shows the polyimide resin compositions, the solubilities, and the evaluation results of the films of the examples.

TABLE 1

| | Monomer Compositions | | | | | | | |
|---|---|---|---|---|---|---|---|---|
| | Acid Dianhydrides | | | | Diamines | | | |
| | CBDA | PMDA-HS | 6FDA | BPDA | TFMB | 3,3′-DDS | 4,4′-DDS | |
| | mol % | mol % | mol % | mol % | mol % | mol % | mol % | Solubility |
| Example 1 | 50 | — | 50 | — | 50 | 50 | — | OK |
| Example 2 | 50 | — | 50 | — | 70 | 30 | — | OK |
| Reference | 50 | — | 50 | — | 70 | 30 | — | — |
| Example 1 | | | | | | | | |
| Example 3 | 50 | — | 50 | — | 80 | 20 | — | OK |
| Example 4 | — | 50 | 50 | — | 80 | 20 | — | OK |
| Example 5 | 60 | — | 40 | — | 70 | 30 | — | OK |
| Example 6 | 65 | — | 35 | — | 70 | 30 | | OK |
| Example 7 | 70 | — | 30 | — | 50 | 50 | — | OK |
| Example 8 | 80 | — | 20 | — | 40 | 60 | — | OK |
| Example 9 | 80 | — | 20 | — | 50 | 50 | — | OK |
| Example 10 | 80 | — | 20 | — | 60 | 40 | — | OK |
| Example 11 | 90 | — | 10 | — | 40 | 60 | — | OK |
| Comparative | — | — | 100 | — | 100 | — | — | OK |
| Example 1 | | | | | | | | |
| Comparative | — | — | 100 | — | 50 | 50 | — | OK |
| Example 2 | | | | | | | | |
| Comparative | 50 | — | 50 | — | 100 | — | — | OK |
| Example 3 | | | | | | | | |
| Comparative | — | 50 | 50 | — | 100 | — | — | OK |
| Example 4 | | | | | | | | |
| Comparative | 50 | — | 50 | — | — | 100 | — | OK |
| Example 5 | | | | | | | | |
| Comparative | 50 | — | 50 | — | 80 | — | 20 | NG |
| Example 6 | | | | | | | | |
| Comparative | 60 | — | 40 | — | 80 | 20 | — | NG |
| Example 7 | | | | | | | | |
| Comparative | 60 | — | 40 | — | 70 | — | 30 | NG |
| Example 8 | | | | | | | | |
| Comparative | 70 | — | 30 | — | 75 | 25 | — | NG |
| Example 9 | | | | | | | | |
| Comparative | 75 | — | 25 | — | 70 | 30 | — | NG |
| Example 10 | | | | | | | | |
| Comparative | 80 | | 20 | | 70 | 30 | — | NG |
| Example 11 | | | | | | | | |
| Comparative | 80 | — | — | 20 | 100 | — | — | NG |
| Example 12 | | | | | | | | |
| Comparative | 85 | — | 15 | — | 65 | 35 | — | NG |
| Example 13 | | | | | | | | |
| Comparative | 90 | — | 10 | — | 60 | 40 | — | NG |
| Example 14 | | | | | | | | |
| Comparative | 90 | — | 10 | — | 70 | 30 | — | NG |
| Example 15 | | | | | | | | |
| Comparative | 100 | — | — | — | — | 100 | — | NG |
| Example 16 | | | | | | | | |
| Comparative | 100 | — | — | — | 50 | 50 | — | NG |
| Example 17 | | | | | | | | |
| Comparative | 100 | — | — | — | 100 | — | — | NG |
| Example 18 | | | | | | | | |

| | Film Characteristics | | | | | | |
|---|---|---|---|---|---|---|---|
| | Pencil | Elastic | Yellowness | Transmittance | Total Light | | |
| | Hardness | Modulus | (YI) | (400 nm) | Transmittance | Haze | Tg |
| | — | GPa | — | % | % | % | ° C. |
| Example 1 | 3H | 3.9 | 1.1 | 85 | 90 | 1.0 | 320 |
| Example 2 | 4H | 3.9 | 1.0 | 86 | 91 | 0.7 | N.D. |
| Reference | 3H | 3.6 | 2.4 | 72 | 91 | 0.7 | N.D. |
| Example 1 | | | | | | | |
| Example 3 | 4H | 4.0 | 1.4 | 80 | 91 | 0.9 | N.D. |
| Example 4 | 3H | 3.0 | −3.5 | 85 | 91 | 1.0 | N.D. |
| Example 5 | 4H | 4.2 | 1.3 | 85 | 90 | 0.8 | 337 |
| Example 6 | 5H | 4.5 | 2.1 | 86 | 92 | 0.8 | 315 |
| Example 7 | 4H | 4.3 | 1.6 | 81 | 87 | 0.9 | N.D. |
| Example 8 | 4H | 4.2 | 1.3 | 85 | 90 | 0.9 | N.D |
| Example 9 | 4H | 4.3 | 1.5 | 85 | 90 | 0.9 | 347 |
| Example 10 | 4H | 4.4 | 1.7 | 85 | 90 | 0.9 | 348 |
| Example 11 | 4H | 4.1 | 2.2 | 85 | 89 | 1.1 | N.D. |
| Comparative | 2H | 3.5 | 1.8 | 78 | 90 | 0.8 | N.D. |
| Example 1 | | | | | | | |
| Comparative | 2H | 3.4 | 1.4 | 84 | 90 | 0.9 | 290 |
| Example 2 | | | | | | | |
| Comparative | 2H | 4.2 | 1.2 | 84 | 91 | 0.7 | 369 |
| Example 3 | | | | | | | |
| Comparative | F | 3.2 | −5.0 | 85 | 91 | 1.0 | N.D. |
| Example 4 | | | | | | | |
| Comparative | 2H | 3.5 | 2.2 | 83 | 89 | 0.7 | 307 |
| Example 5 | | | | | | | |
| Comparative | | | | | | | |
| Example 6 | | | | | | | |
| Comparative | | | | | | | |
| Example 7 | | | | | | | |
| Comparative | | | | | | | |
| Example 8 | | | | | | | |
| Comparative | | | | | | | |
| Example 9 | | | | | | | |
| Comparative | | | | | | | |
| Example 10 | | | | | | | |
| Comparative | | | | | | | |
| Example 11 | | | | | | | |
| Comparative | 5H | 5.2 | 3.0 | 85 | 90 | 1.3 | 362 |
| Example 12 | | | | | | | |
| Comparative | | | | | | | |
| Example 13 | | | | | | | |
| Comparative | | | | | | | |
| Example 14 | | | | | | | |
| Comparative | | | | | | | |
| Example 15 | | | | | | | |
| Comparative | | | | | | | |
| Example 16 | | | | | | | |
| Comparative | | | | | | | |
| Example 17 | | | | | | | |
| Comparative | | | | | | | |
| Example 18 | | | | | | | |

For all the polyimides of Examples 1-11, gelation of the solution did not occur during imidization from the polyamic acid solution, and the isolated polyimide resin was soluble in methyl ethyl ketone, indicating a high solubility with respect to an organic solvent. Further, for all the polyimide films (thickness: 30 μm) of Examples 1-11, the yellowness (YI) was 2.5 or less and the transmittance at a wavelength of 400 nm was 80% or more, indicating an excellent transparency; and the pencil hardness was 3H or more, indicating a high mechanical strength.

For Comparative Example 1 and Comparative Example 2, in which only 6FDA was used as an acid dianhydride, the polyimides exhibited the same high solubility as the polyimides of Examples, but the pencil hardness of the films was 2H, indicating that the mechanical strength was insufficient. When only CBDA was used as an acid dianhydride, in all of an example (Comparative Example 18) in which only TFMB was used as a diamine, an example (Comparative Example 16) in which only 3,3′-DDS was used as a diamine, and an example (Comparative Example 17) in which TFMB and 3,3′-DDS were used as diamines at a ratio of 50:50, gelation occurred during imidization from a polyamic acid solution, and no polyimide resin was obtained. From these results, it can be seen that, when only a fluorine-containing aromatic acid dianhydride is used as an acid dianhydride component, the mechanical strength is insufficient, and, when only an alicyclic acid dianhydride is used as an acid dianhydride component, the solubility is decreased.

In Comparative Example 3 in which only TFMB was used as a diamine and CBDA and 6FDA were used at a ratio of 50:50 as acid dianhydrides, the mechanical strength of the polyimide film was insufficient. In Comparative Example 4 in which PMDA-HS was used instead of CBDA, further, the pencil hardness was lower than that of Comparative Example 3.

In Comparative Example 5 in which only 3,3′-DDS was used as a diamine and CBDA and 6FDA were used at a ratio of 50:50 as acid dianhydrides, the pencil hardness was 2H similar to Comparative Example 3, and, as compared to Comparative Example 3, the YI was larger and the transparency was lower. In a comparison between Example 1, Example 2 and Comparative Example 5, a tendency was observed that, as the amount of the 3,3-DDS was increased, the transmittance at the wavelength of 400 nm was decreased, and the YI was increased and the transparency was decreased (coloration occurred).

From a comparison between Example 3 and Comparative Example 7 and a comparison between Example 6 and Comparative Example 10, a tendency was observed that, when the diamine components were the same, the solubility was decreased as the ratio of the alicyclic acid dianhydride in the acid dianhydride components was increased. From a comparison between Example 3 and Example 4, and a comparison between Comparative Example 3 and Comparative Example 4, a tendency can be seen that, when PMDA-HS was used instead of CBDA as the alicyclic acid dianhydride, the transparency was improved and the mechanical strength was reduced.

From a comparison between Example 5 and Comparative Example 7, a comparison between Example 7 and Comparative Example 9, a comparison between Examples 8-10 and Comparative Example 11, and a comparison between Example 11 and Comparative Examples 14 and 15, it can be seen that, when the acid dianhydride components were the same, the solubility was improved with an increase in the ratio of the 3,3′-DDS in the diamines. A tendency was observed that, when 4,4′-DDS was used instead of 3,3′-DDS, gelation occurred during imidization in a solution, and the solubility in an organic solvent was decreased (comparison between Example 3 and Comparative Example 6 and comparison between Example 5 and Comparative Example 8). From these results, a tendency can be seen that, when the diamine components are a combination of the fluoroalkyl-substituted benzidine and the 3,3-DDS, the solubility is improved as compared to when only the fluoroalkyl-substituted benzidine is used, whereas when the fluoroalkyl-substituted benzidine and the 4,4′-DDS are used, the solubility is decreased (for example, comparison between Comparative Example 3 and Comparative Example 6).

It can be seen that, in examples in which the alicyclic acid dianhydride (CBDA or PMDA-HS) and the fluorine-containing aromatic diamine (6FDA) are used as acid dianhydrides and the fluoroalkyl-substituted benzidine (TFMB) and the 3,3′-DDS are used as diamines (Examples 1-11, and Comparative Examples 7, 9-11, 13-15), when points formed by plotting the ratio (x) of the 3,3′-DDS in the diamines and the ratio (y) of the CBDA in the acid dianhydrides are on a lower right side of straight lines (4b) and (4c) in FIG. 1, that is, when y≤0.4x+70 and y≤1.8x+20 are satisfied, gelation during imidization in a solution does not occur and a high solubility is exhibited.

From a comparison between Example 2 and Reference Example 1 in which polyamic acids of the same composition were used, it can be seen that, as compared to a case where a film is produced from a polyamic acid solution, by performing imidization in a solution and forming a film from a polyimide resin solution, a polyimide film having a high mechanical strength (pencil hardness), less coloration and a high transparency (high transmittance at a wavelength of 400 nm and a low YI) can be obtained. In Comparative Example 12, the polyimide film produced from the polyamic acid solution exhibited a high pencil hardness, but the YI was 3.0, indicating a poor transparency.

From the above results, it can be seen that, by using the alicyclic acid dianhydride and the fluorine-containing aromatic diamine as the acid dianhydrides, and using the fluoroalkyl-substituted benzidine and the 3,3′-DDS as the diamines, and by setting ratios of these components within predetermined ranges, gelation does not occur during imidization from a polyamic acid solution and a polyimide resin can be isolated, and a polyimide film having excellent transparency and mechanical strength can be obtained.

1. A polyimide resin, comprising:
structures derived from acid dianhydrides; and
structures derived from diamines,
wherein the acid dianhydrides include an alicyclic acid dianhydride and a fluorine-containing aromatic acid dianhydride in a total amount of 70 mol % or more with respect to a total amount of 100 mol % of the acid dianhydrides,
the diamines include 3,3′-diaminodiphenyl sulfone and a fluoroalkyl-substituted benzidine in a total amount of 70 mol % or more with respect to a total amount of 100 mol % of the diamines, and wherein
the acid dianhydrides and the diamines satisfy:
10x≤90;
15≤y≤95;
y≤0.4x+70;
y≤1.8x+20; and
y−x≥−50.
where x is a content of the 3,3′-diaminodiphenyl sulfone with respect to the total amount of 100 mol % of the 3,3′-diaminodiphenyl sulfone and the fluoroalkyl-substituted benzidine, and y is a content of the alicyclic acid dianhydride with respect to the total amount of 100 mol % of the alicyclic acid dianhydride and the fluorine-containing aromatic acid dianhydride.

2. The polyimide resin according to claim 1, wherein the alicyclic acid dianhydride is at least one selected from the group consisting of 1,2,3,4-cyclobutanetetracarboxylic acid dianhydride, 1,2,3,4-cyclopentanetetracarboxylic acid dianhydride, and 1,2,4,5-cyclohexanetetracarboxylic acid dianhydride.

3. The polyimide resin according to claim 1, wherein the fluorine-containing aromatic acid dianhydride is 2,2-bis(3,4-dicarboxyphenyl)-1,1,1,3,3,3-hexafluoropropane dianhydride.

4. The polyimide resin according to claim 1, wherein the fluoroalkyl-substituted benzidine is 2,2′-bis (trifluoromethyl) benzidine.

5. The polyimide resin according to claim 1, wherein 45≤y≤85 is satisfied.

6. The polyimide resin according to claim 1, wherein y≥x is satisfied.

7. The polyimide resin according to claim 1, wherein:
the diamines include 3,3′-diaminodiphenyl sulfone in an amount of 20-60 mol % with respect to the total amount of 100 mol % of the diamines, and
the acid dianhydrides include 1,2,3,4-cyclobutanetetracarboxylic acid dianhydride in an amount of 35-80 mol % with respect to the total amount of 100 mol % of the acid dianhydrides.

8. A method for producing the polyimide resin according to claim 1, comprising:
causing the diamines and the acid dianhydrides to react with each other in a solvent such that a polyamic acid is prepared;
mixing a dehydrating agent and an imidization catalyst with the polyamic acid solution such that the polyamic acid is imidized and that a polyimide solution is obtained; and
mixing the polyimide solution with a poor solvent for a polyimide such that the polyimide resin is precipitated.

9. A polyimide solution, produced by a process including dissolving the polyimide resin of claim 1 in an organic solvent.

10. The polyimide solution according to claim 9, wherein the organic solvent is a ketone-based solvent.

11. A polyimide film, comprising:
the polyimide resin of claim 1.

12. The polyimide film according to claim 11, having a yellowness of 3.0 or less.

13. The polyimide film according to claim 11, having a pencil hardness of 3H or higher.

14. The polyimide film according to claim 11, having a light transmittance of 70% or more at a wavelength of 400 nm.

15. The polyimide film according to claim 11, having a glass transition temperature of 300° C. or higher.

16. The polyimide film according to claim 11, having a thickness of 20 μm or more.

17. A method for producing a polyimide film comprising:
applying the polyimide solution of claim 9 onto a substrate; and
removing the solvent.

18. The polyimide resin according to claim 1, wherein the alicyclic acid dianhydride is 1,2,3,4-cyclobutanetetracarboxylic acid dianhydride, the fluorine-containing aromatic acid dianhydride is 2,2-bis(3,4-dicarboxyphenyl)-1,1,1,3,3,3-hexafluoropropane dianhydride, and the fluoroalkyl-substituted benzidine is 2,2′-bis (trifluoromethyl) benzidine.

19. The polyimide resin according to claim 18, wherein 45≤y≤85 is satisfied.

20. The polyimide resin according to claim 18, wherein y≥x is satisfied.
